(19) United States
(12) Patent Application Publication
(10) Pub. No.: US 2022/0096909 A1
(43) Pub. Date: Mar. 31, 2022

(54) BAG TOSS GAME WITH MULTIPLE GAME PLAY OPTIONS

(71) Applicant: Bay Tek Entertainment, Inc., Pulaski, WI (US)

(72) Inventors: Cory Russell, Sobieski, WI (US); Mark Johnson, Green Bay, WI (US)

(73) Assignee: Bay Tek Entertainment, Inc., Pulaski, WI (US)

(21) Appl. No.: 17/483,940

(22) Filed: Sep. 24, 2021

Related U.S. Application Data
(60) Provisional application No. 63/084,810, filed on Sep. 29, 2020.

(51) Int. Cl. A63B 67/06; A63B 71/06; H05B 47/19; H05B 47/115; H05B 45/10

(52) U.S. Cl. CPC A63B 67/06; A63B 71/0605; H05B 47/19; H05B 47/115; A63B 2071/0694; A63B 2225/74; A63B 2225/50; A63B 2220/805; H05B 45/10

(57) ABSTRACT

A bag toss game for use by one or more players to play user-selected game modes. The bag toss game includes a plurality of target holes arranged on a game board. Each of the target holes includes a sensor that detects when a bag passes through the target hole. Each of the target holes includes one or more LEDs that illuminate the target holes as part of the game mode. The game board includes a controller that both registers the passage of a bag through the target hole as detected by the sensor and illuminates the LEDs. The game board includes a wireless transceiver that allows the controller to communicate with a mobile device. The communication between the mobile device and the controller allows the player to select between multiple game modes and to receive live scoring updates and visual displays of the game play.

### CROSS REFERENCE TO RELATED APPLICATIONS

The present application is based on and claims priority to U.S. Provisional Patent Application Ser. No. 63/084,810, filed Sep. 29, 2020, the disclosure of which is incorporated herein by reference.

### BACKGROUND

The present disclosure generally relates to a bag toss game that includes at least one game board having multiple target holes that each include a sensor and indicator lights. More specifically, the present disclosure relates to a bag toss game and software application in which the game board communicate to one or more smartphones to control the game operation and scoring.

Presently, bag toss games, often referred to as cornhole games, are a popular outdoor game that are played at parties, tailgates or as tournaments. Typical bag toss games include two game boards that are separated by a defined distance. Each game board includes a single target hole. The two players (or two teams of players) take turns throwing three bags each at the target hole on a first game board from a location next to the second game board. After a round, the players calculate a round score and retrieve the bags and throw the bags at the second game board. This continues until one player or team of players achieves a target score of typically twenty-one. Although this game play is hugely popular, there is very little variation in game play.

The inventors have recognized the popularity of a conventional bag toss game but have recognized the need and desire for enhanced game play and different game modes. Further, the inventors have recognized the desire for integration of the game play with electronic devices, such as smartphones, to enhance the enjoyment of the game play.

### SUMMARY

The present disclosure generally relates to a to a bag toss game that includes at least one game board having multiple target holes. More specifically, the present disclosure relates to a game board that includes a controller that can wirelessly communicate with a mobile device, such as a smartphone, to allow a player to select between multiple game modes and to monitor the game play on a display of the smartphone.

The game board includes a plurality of target holes that are arrange in a desired pattern. The target holes are sized to allow a bag to pass through the target hole when properly thrown and directed by the player. A controller is mounted to the game board and operates to control the operation of one of a plurality of game modes.

The game board further includes a wireless transmitter that is in connected to the controller of the game board. The wireless transmitter allows the controller to communicate with a mobile device, such as a smartphone, of the player. Through the wireless transceiver, the controller can send scoring information to either a central display or to a mobile smartphone or similar electronic device carried by one or more of the players. The players are able to select between a plurality of game modes using mobile application software downloaded onto their smartphone. In this manner, the bag toss game can be player controlled.

The players can select between various different versions of target type games that can be played utilizing the layout of target holes. In an exemplary embodiment, the game board can include nine target holes. Once a game play mode is selected, a central controller in the game board controls the operation of LED lights to illuminate targets on the game board. During game play, a sensor associated with each of the target holes detect the passage of a bag through the target hole as thrown by the players. The controller uses the detection of the bag to carry out the game play based on the game mode selected by the player. In addition, the controller communicates the detected bags to the smartphone application software for presentation to the player.

Various other features, objects and advantages of the invention will be made apparent from the following description taken together with the drawings.

### BRIEF DESCRIPTION OF THE DRAWINGS

The drawings illustrate the best mode presently contemplated of carrying out the disclosure. In the drawings:

FIG. 1 is a perspective view of two players playing a bag toss game using the game board of the present disclosure;

FIG. 2 is a front perspective view of the game board and several bags;

FIG. 3 is a schematic illustration of the electronic operating components in at least one of the game boards;

FIG. 4 is a section view of one of the game boards of the present disclosure showing the LEDs and the sensor associated with each of the target holes;

FIGS. 5A and 5B are an operational flow diagram of the nine different game modes in accordance with an exemplary embodiment of the present disclosure;

FIG. 6 is a screen shot of the initial selection screen of the application software controlling the game play;

FIG. 7 is a screen shot of the PopCorn game mode;

FIG. 8 is a screen shot of the Corn Holy game mode;

FIG. 9 is a screen shot of the 3 In-A-Row game mode; and

FIG. 10 is a screen shot of the Chase the Dragon game mode.

### DETAILED DESCRIPTION

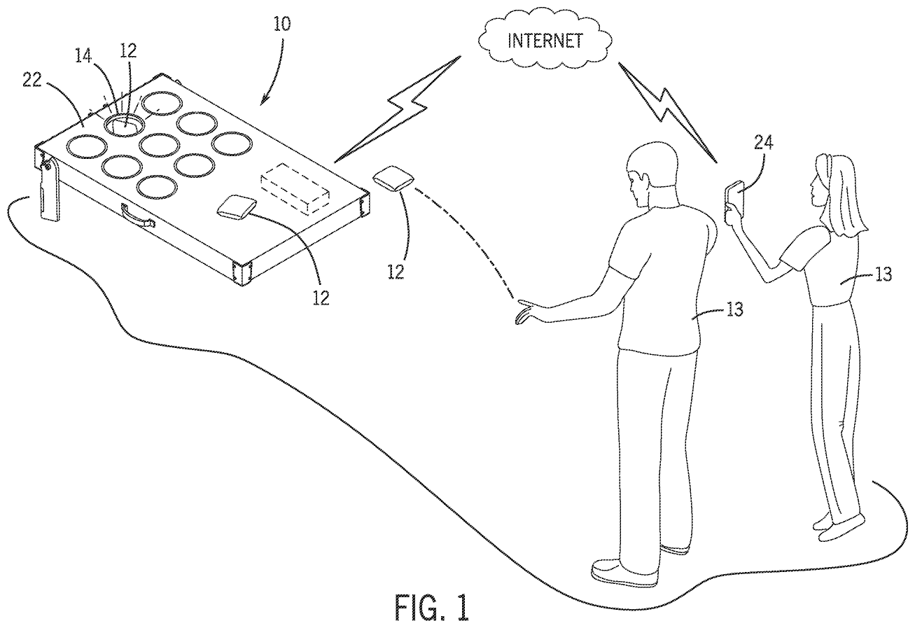

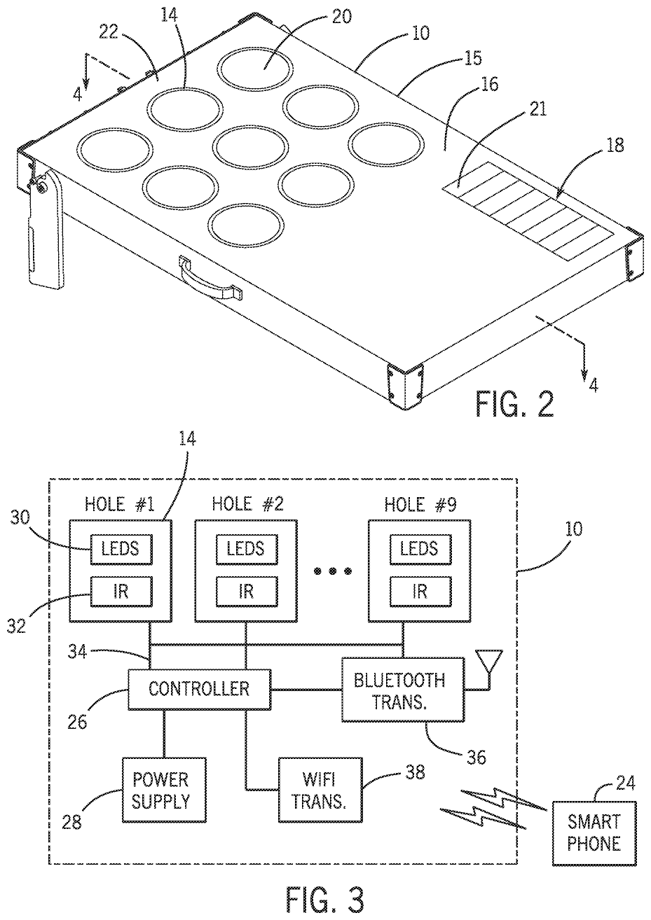

FIGS. 1 and 2 illustrates a game board 10 used to play one of several bag toss games and constructed in accordance with the present disclosure. The game board 10 shown in FIGS. 1 and 2 is designed to be used with bags 12, which are similar to those used in a cornhole game that is currently known. The bags 12 are of a standard size and are filled with feed corn. In the embodiment shown in FIGS. 1 and 2, the game board 10 includes a series of target holes 14 that are aligned in a specific pattern. In the embodiment shown in FIGS. 1 and 2, nine target holes 14 are organized in three rows of three in an upper half 15 of the game board 10. Each of the target holes 14 has a specific diameter sized to receive one of the bags 12. Although a specific number and configuration of the target holes 14 is shown, the target holes 14 could be arranged in a different pattern and could include a different number of overall holes.

The lower half 16 of the game board 10 is formed without any of the target holes 14 and provides a landing area for the bags 12 during game play. During game play, one or more players 13 stand a prescribed distance from the game board 10 and throw a desired number of bags 12 toward the game board 10 attempting to cause the bag to land on the outer surface 22 and slide toward and pass through a desired target hole 14 or to pass directly through the desired target hole 14. The bags 12 are sized to be able to pass through the target holes 14.

As shown in FIG. 2, the lower half 16 of the game board 10 includes a game selection display area 18 that includes a listing of the different types of game modes that are available utilizing the bag toss game of the present disclosure. The display area 18 includes a series of lighted indicators 21 that are located either to the side or beneath the textual name of the game modes that are available for play. The lighted indicators provide a visual indication of the game mode selected and being played.

The game board 10 includes an internal battery that is used to provide illumination to the display area 18 as well as to each of the target holes 14. It is contemplated that the power supply contained within the game board 10 could be a rechargeable battery power supply or could be replaceable batteries. In an alternate embodiment, the game board could include an internal transformer that would allow the game board to be connected to a utility power supply available at the location where the game is being played.

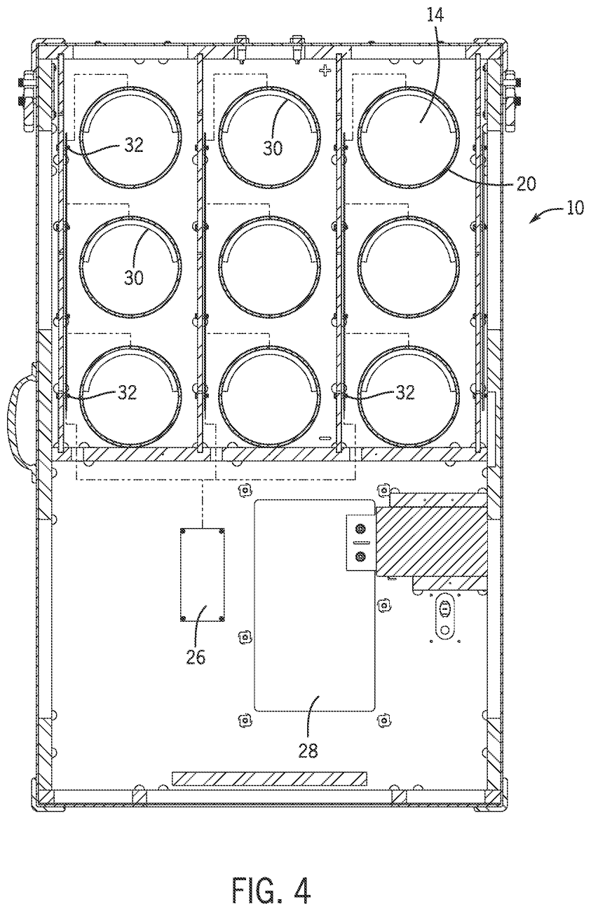

FIG. 4 provides an internal view of the game board 10 with the outer surface removed to expose the internal electrical operating components. As shown, each of the target holes 14 includes an internal wall 20 that extends below the outer surface of the game board. In the embodiment illustrated, the internal wall 20 is backlit by a series of LEDs 30 such that each of the target holes 14 can be illuminated separately through activation of the LEDs 30. The LEDs 30 can be provided on an LED strip that is controlled by a controller in a manner to be discussed below. The LEDs 30 are located on the exterior of the internal wall 20 such that the bags do not contact the LEDs 30 during game play. The internal wall is constructed to be either transparent or translucent to allow the light generated by the LEDs to pass through the internal wall 20. It is contemplated that the internal wall 20 could be backlit by LEDs 30 that can have multiple different colors.

As can also be seen in FIG. 4, each of the internal walls 20 conceals a detection sensor 32. The sensor 32 can be one of multiple types of sensors that are able to detect the passage of an item, such as a bag, past the sensor 32. In the contemplated embodiment illustrated, the sensor 32 is an infrared (IR) sensor positioned to detect when one of the bags 12 passes through the scoring hole formed by the internal wall 20. The internal sensor 32 is able to detect the passage of one of the bags 12 through the internal wall 20. Upon detecting a bag, the sensor 32 provides an indication of this sensing to an internal controller located in the game board, as will be described in greater detail below. Although the sensor 32 is shown and described as being an IR sensor, other sensors such as optical through-beam sensors, ultrasonic sensors or magnetic sensors combined with metallic elements in the bags could be use while operating within the scope of the present disclosure.

During one of the selected game modes, one or more of the target holes 14 can be illuminated with different colors of the LEDs 30 depending upon type of game play. As will be discussed below, the lighted internal walls 20 provide an indication of a target for the player or provide an indication of which of the target holes 14 has already been hit by the player.

FIG. 3 provides an electrical schematic illustration of the system of the present disclosure. As shown in FIG. 3, each of the game boards 10 is able to communicate with other devices utilizing a wireless communication technique, such as Bluetooth. In the embodiment illustrated, the external device is shown as a smartphones 24. However, other similar type of handheld devices could be used in place of the smartphone 24, such as a tablet, watch, laptop computer or something similar that includes a display and a user input device, such as a touch screen or keyboard. The game board 10 is able to both receive and send wireless communications to the smartphone 24 during game play.

In the embodiment shown, the game board 10 includes a central controller 26 that is connected to a power supply 28. As discussed previously, the power supply 28 could be a rechargeable or replaceable battery or a transformer connected to a utility power supply to convert AC power to DC power. The central controller 26 is connected to individual components at each of the individual target holes 14. As illustrated, Hole 1 includes a series of LEDs 30 as well as a sensor 32. The central controller 26 communicates over a communication line 34 to both send and receive information from both the LEDs 30 and the sensor 32 associated with target Hole 1. As illustrated, the central controller 26 is connected to each of the nine target holes shown in the embodiment of the present disclosure. The controller 26 is able to separately control the sensor 32 and LEDs 30 associated with each of the target holes 14.

The central controller 26 is further connected to a Bluetooth transceiver 36. The Bluetooth transceiver 36 can communicate wirelessly to one or more smartphones 24 or any other type of Bluetooth enabled device. The Bluetooth transceiver 36 is able to both send information and receive information from the external device, such as the smartphone 24. Although Bluetooth is shown and described as the preferred short-range wireless communication technique, other wireless communication techniques could be used in place of Bluetooth.

In addition to the Bluetooth transceiver 36, the controller 26 could also include a Wi-Fi transceiver 38. The Wi-Fi transceiver allows the central controller 26 communicate utilizing conventional Wi-Fi communication techniques. In this manner, the controller 26 would be able to communicate not only to local hand-held devices, such as the smartphones 24, but also to remote locations utilizing conventional Wi-Fi communication techniques. The wireless communication to the controller 26, whether through Wi-Fi or Bluetooth, allows for updates to be downloaded to the controller. These updates could be modified or new game modes, lighting changes for any of the game modes, or any other modifications to the game modes. The communication also allows for real-time game play displayed on the smartphones 24 during actual game play.

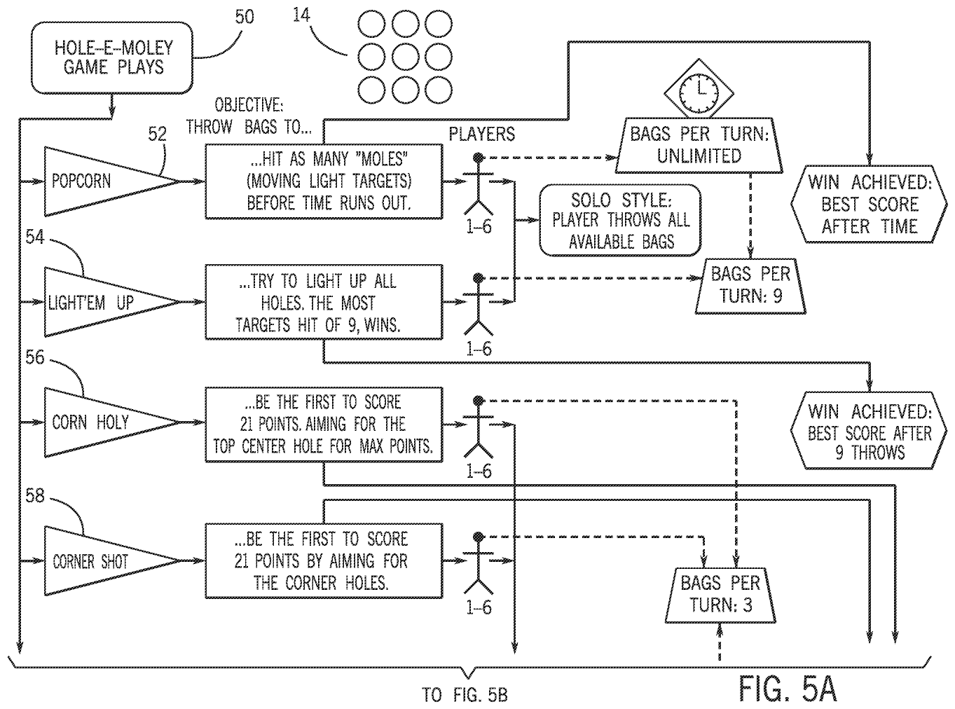

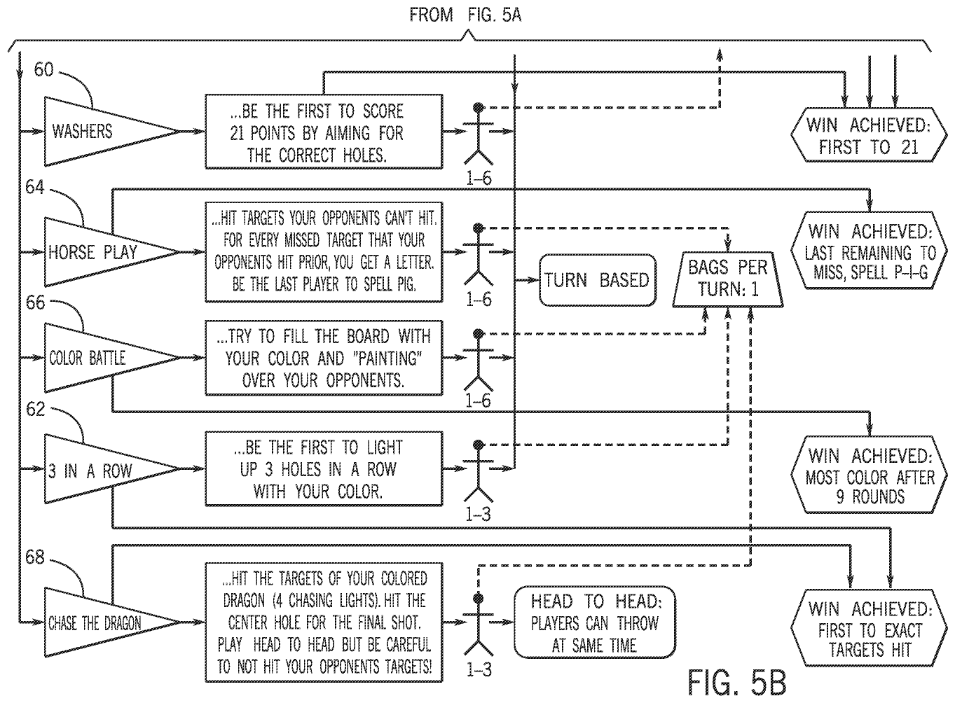

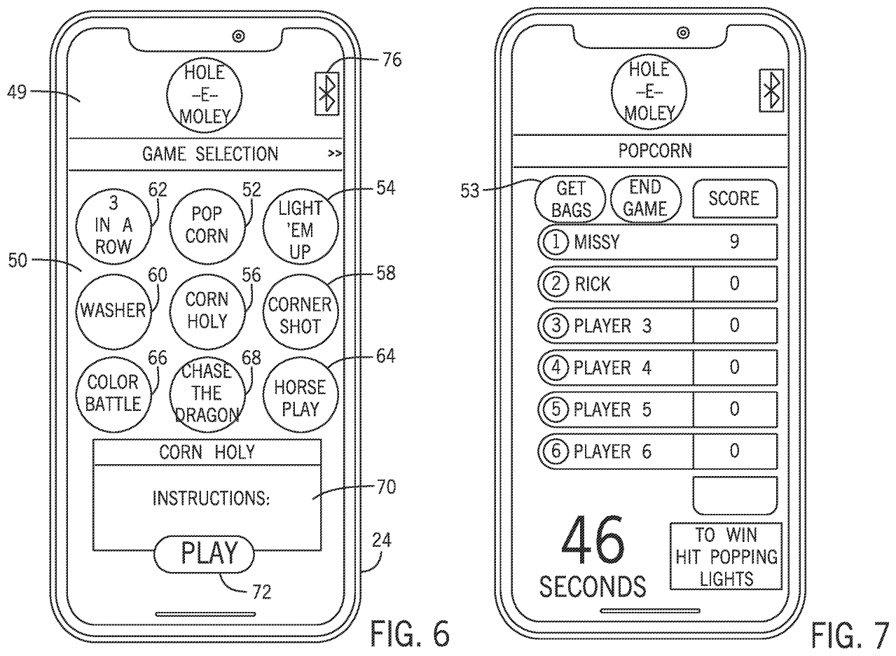

FIGS. 5A-5B generally illustrates the multiple different types of game mode that are available utilizing the bag toss game of the present disclosure. As illustrated in FIG. 5A, the target holes 14 are shown in the desired configuration. FIG. 6 is the initial start screen 49 shown on the smartphone 24 of a user. Prior to playing, the user downloads application software that operates on the smartphone 24. When the application software is run by the player, the application software causes the initial start screen 49 to be displayed on the smartphone 24. As shown in both FIGS. 5A and 6, a selection block 50 is displayed and causes the player to engage in the first step of game play, which is the selection of the game mode. In the embodiment illustrated, nine different types or modes of game play are illustrated. The details of each of the nine different types of game play are set forth below:

PopCorn: Six Players, Unlimited Bags (9 Available), 60 Seconds

The PopCorn mode is shown on the start screen 49 screen of FIG. 6 and by indicator 52 in FIG. 5A. In this mode, a player presses “GO” on the application software and has sixty seconds to throw bags to hit as many “moles” (lit targets) as possible. The controller controls which of the target holes are illuminated as targets for the player. The active player will start with all nine bags and if they run out of bags before time is up, the player can pause the game by pressing the “Get Bags” button 53. As time transpires, more moles populate the board, giving the player more targets to hit. Five points are given for each mole hit. After all participants have played, all moles are counted up and the winner is determined. App control: [Go] button to start game. [Get Bags] button to pause/start timer. Game automatically advances to next player after time expires.

Light 'Em Up: Six Players, all Nine Bags Per Player, One Round

This gameplay option is shown by reference number 54 in FIG. 5A and FIG. 6. In this game mode, a player starts with a dark board. He/she throws each bag toward an open hole. If he hits the hole, the controller lights up the target hole and the player can aim for a different target hole. Player throws all remaining bags to try hit all open (dark) holes. If the player hits all nine target holes, the player achieves a perfect game. The winner is determined after all players throw nine bags, by the player that has hit the most targets. App control: In the likely occurrence the player misses one or more targets, (therefore bags are not detected as thrown) they will need to hit the [DONE THROWING] button to advance to the next player in the game. If all targets are hit, the game automatically advances to next player. The [RETRIEVE BAGS] button needs to be depressed between rounds or as needed.

Corn Holy: Six Players, Three Bags Per Player/Turn

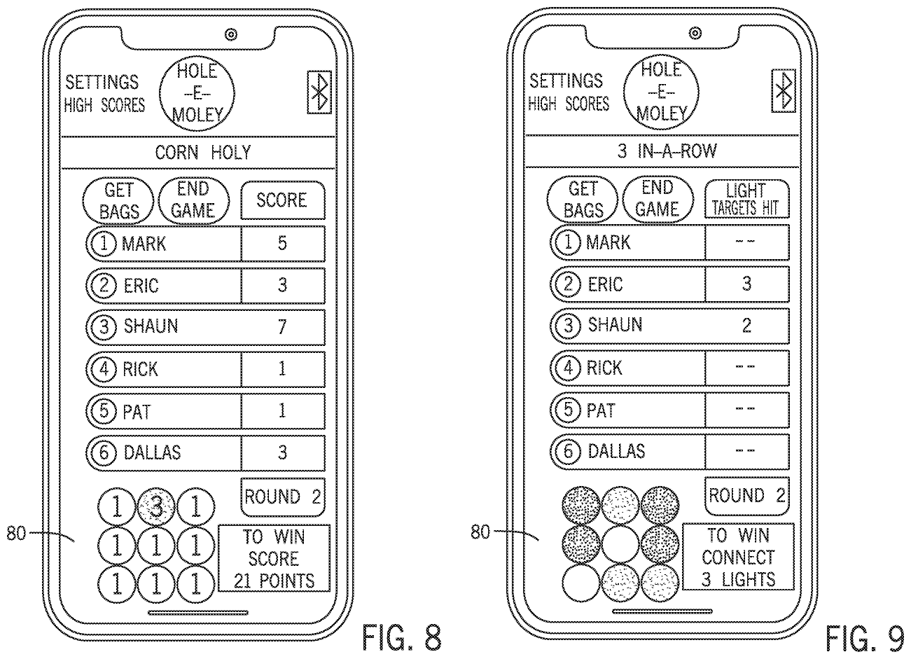

The Corn Holy game play is shown in the application screen of FIG. 8 and by indicator 56 in FIG. 5A. In this game mode, players throw three bags at a time in order to score points against their opponents. Players score three points for the top center hole, and one point for the other eight holes on the board. No points are awarded for bags that land on the board and do not pass through one of the target holes. There is no “score cancellation” in this version of Corn Hole. The first player to twenty-one wins. App control: At the end of each turn, if one or more bags do not score, the player will hit the [DONE THROWING] button to advance the game to the next player. If all three bags score, game automatically advances to subsequent player. Also, [RETRIEVE BAGS] between rounds or as needed.

Corner Shot: Six Players, Three Bags Per Player/Turn

The Corner Shot game mode is shown by indicator 58 in FIG. 3. In this game mode, players throw three bags at a time at the game board in order to score points against their opponents. Corner targets are worth more points but switch values over time. A target hole illuminated blue=three points, illuminated red=two points, illuminated white=one point. The first player to twenty-one points wins. App control: At the end of each turn, if one or more bags do not score, the player will hit the [DONE THROWING] button to advance the game to the next player. If all three bags score, game automatically advances to subsequent player. Also, [RETRIEVE BAGS] between rounds or as needed.

Washers: Six Players, Three Bags Per Player/Turn

The Washers game play is shown by indicator 60 in FIG. 6. In this game mode, players throw three bags at a time in order to score points against their opponents. Players score five points if they hit the center target hole, and one point if they hit the surrounding target holes. If a player scores in the same target immediately following their previous opponent, they steal the points from that player. The first player to twenty-one wins. App control: At the end of each turn, if one or more bags do not score, the player will hit the [DONE THROWING] button to advance the game to the next player. If all three bags score, game automatically advances to subsequent player. Also, [RETRIEVE BAGS] between rounds or as needed.

3 In-a-Row: Three Players, One Bag Per Player/Turn

The 3-in-a-row game play is shown in the application screen of FIG. 9 and by indicator 62 in FIG. 6. In this game mode, players throw one bag at a time to light the target hole with their color. Subsequent players can throw toward an open hole OR throw in one of their opponents' colored targets to “steal” that target hole. Be the first to get three targets lit in a row with the same color. App control: At the end of each turn, if the player does not score a hole, that player should hit the [MISS] button to end their turn and advance to the next player. If a target is detected, the game automatically advances to the next player/round. Also [RETRIEVE BAGS] between rounds or as needed.

Horse Play: Six Players, One Bag Per Player/Turn

The Horse Play game play is shown by indicator 64 in FIG. 6. In this game mode, which is similar to the classic basketball game Horse, players take turns per round taking the lead “shot”. By making their throw in any target, they “activate” that target as the intended target for the other players. Subsequent players need to hit that target with their toss of the bag. If the subsequent players miss that target, the players accumulate one of five letters (H.O.R.S.E.). If the player makes that target, play continues with the next player or round. If Player A leads round 1, Player B would lead round 2 and so on. If the lead player misses their shot, they automatically accumulate a letter and the subsequent player can now choose/shoot for an open target for all remaining players to hit. Once a player spells HORSE, they are eliminated from the game, and play continues with the remaining players until a winner is determined. App control: At the end of each turn, if the player does make the shot (or if the leader does not score a target), that player should hit the [MISS] button to end their turn and advance to the next player. If a target is detected, the game automatically advances to the next player/round. Also, [RETRIEVE BAGS] between rounds or as needed.

Color Battle: Six Players, One Bag Per Player/Turn

The Color Battle game play is shown by indicator 66 in FIG. 6. In this game mode, players throw one bag at a time to light any target with their color. The goal is to try to fill the board with your designated color by hitting all nine target holes. After nine rounds of play, all target lights are counted, and the winner is determined. App control: At the end of each turn, if the player does not score a hole, that player should hit the [MISS] button to end their turn and advance to the next player. If a target is detected, the game automatically advances to the next player/round. Also, [RETRIEVE BAGS] between rounds or as needed.

Chase the Dragon: Three Players, Split Bags Between Players. Can Throw Simultaneous or Turn-Based

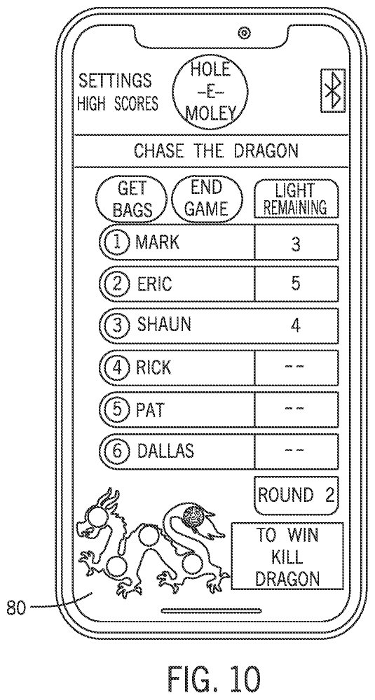

The Chase the Dragon game play is shown in the application screen of FIG. 10 and by indicator 68 in FIG. 6. In this game mode, players (two at a time) divide the available bags so they can throw bags simultaneously or turn-based at a board of moving targets (dragons). The targets start as a chain of four chase lights representing each player's color. Each time your colored dragon is hit, the tail of the dragon decreases by one light. To win, be the first to “kill” your dragon by hitting all four lights and then the center target. Be careful not to hit your opponent's dragon, or you will score for them. In a 3-player game, each dragon will have three chase lights. App control: Press [RETRIEVE BAGS] as needed.

As indicated above, FIG. 6 is a representation of the initial starting screen as shown on a smartphone. As illustrated, the user can pick between one of the nine game modes described above. Once one of the game modes is initially selected, an information screen 70 provides a brief description of the type of game play. If the user wishes to play this game, the user depresses the play button 72 and the game play begins. When game play begins, a game mode specific screen, such as shown in the selected game mode of FIGS. 7-10 is shown to the player or players.

The initial starting screen shown in FIG. 6 also includes a communication display status indicator 76. In the embodiment shown, the standard Bluetooth icon is shown indicating a successful Bluetooth connection between the game board and the user device, such as a smartphone. If Wi-Fi wireless communication were being used, a standard Wi-Fi icon would be displayed in this location to signify a successful connection.

During actual game play, each of the game mode screens, such as shown in FIGS. 7-10 can include a visual representation of the status of the target holes. As an example, FIGS. 8 and 9 show the target hole status in the representation of the target holes as indicated by reference numeral 80. The target holes would also be illuminated by the LEDs but the display area 80 allows the player or players to view the current game status.

As can be understood by the above description, the bag toss game of the present disclosure allows for a multitude of different types of game play as compared to a typical cornhole which includes a single hole. In addition, each of the game boards includes a communication device that allows the game board itself to communicate with one or more smartphones, such as through a Bluetooth receiver. It is contemplated that each of the two game boards could either communicate separately to the smartphones or could communicate to each other and only one of the game boards communicates to the smartphone.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

We claim:

1. A bag toss game for use by one or more players having a mobile device, comprising:
at least one game board having a plurality of target holes;
at least one bag for tossing onto the game board;
a controller included in the game board;
a wireless transceiver for communicating between the controller and the mobile device; and
application software downloadable onto the mobile device and operable by the player to select one of a plurality of game modes.

2. The bag toss game of claim 1 further comprising a plurality of LEDs, at least one of the plurality of LEDs being associated with each of the plurality of target holes, wherein the controller operates the plurality of LEDs based on the selected game mode.

3. The bag toss game of claim 2 wherein the controller operates the plurality of LEDs to illuminate the plurality of target holes to indicate a desired target hole for the players and turns off select LEDs to indicate non-desired target holes.

4. The bag toss game of claim 1 further comprising a sensor associated with each of the target holes and operable to detect the passage of one of the bags through the associated target hole, wherein each of the sensors is in communication with the controller.

5. The bag toss game of claim 1 wherein the game board includes nine target holes arranged in three rows of three target holes in each row.

6. The bag toss game of claim 1 wherein the application software communicates with the controller to control the game play of the selected game mode.

7. The bag toss game of claim 6 wherein the application software includes a game screen including a representation of the plurality of target holes.

8. The bag toss game of claim 7 wherein the representation of the plurality of target holes includes an indication of the desired target holes for the selected game mode.

9. A bag toss game having a plurality of game modes for play by at least one player that has a mobile device, comprising:
at least one game board having a plurality of target holes that extend through a top surface of the game board;
at least one bag for tossing onto the game board;
a controller included in the game board;
a sensor associated with each of the plurality of target holes and operable to detect the passage of one of the bags through the associated target hole, wherein each of the sensors is in communication with the controller;
a plurality of LEDs, at least one of the plurality of LEDs being associated with each of the plurality of target holes, wherein the plurality of LEDs in communication with the controller; and
a wireless transceiver for communicating between the controller and the mobile device,
wherein the controller controls the operation of the plurality of LEDs based on a selected game mode and the detection of the passage of one of the bags through the target hole during game play.

10. The bag toss game of claim 9 wherein the controller activates the LEDs to indicate a desired target hole.

11. The bag toss game of claim 9 further comprising a hole liner positioned in each target hole and extending below the top surface of the game board.

12. The bag toss game of claim 11 wherein the sensor and the one or more LED associated with each target hole is located to an exterior of the hole liner and the bag passes through an interior of the bag liner.

13. A bag toss game for play by at least one player that has a mobile device, comprising:
at least one game board having a plurality of target holes that extend through a top surface of the game board;
at least one bag for tossing onto the game board;
a controller included in the game board;
a sensor associated with each of the plurality of target holes and operable to detect the passage of one of the bags through the associated target hole, wherein each of the sensors is in communication with the controller;
a plurality of LEDs, at least one of the plurality of LEDs being associated with each of the plurality of target holes, wherein the plurality of LEDs in communication with the controller;
a wireless transceiver for communicating between the controller and the mobile device; and
application software downloadable onto the mobile device and operable by the player to select one of a plurality of game modes.

14. The bag toss game of claim 13 wherein the controller controls the operation of the plurality of LEDs based on the selected game mode and the detection of the passage of the bag through the target holes during game play.

15. The bag toss game of claim 13 wherein the controller activates the LEDs to indicate a desired target hole.

16. The bag toss game of claim 13 further comprising a hole liner positioned in each target hole and extending below the top surface of the game board.

17. The bag toss game of claim 16 wherein the sensor and the one or more LED associated with each target hole is located to an exterior of the hole liner and the bag passes through an interior of the bag liner.
